(19) United States
(12) Patent Application Publication
(10) Pub. No.: US 2014/0011525 A1
(43) Pub. Date: Jan. 9, 2014

(54) Information aggregation display method and device for location based service

(71) Applicant: Zhihao Zheng, Shenzhen (CN)

(72) Inventor: Zhihao Zheng, Shenzhen (CN)

(73) Assignee: TENCENT TECHNOLOGY (SHENZHEN) COMPANY LIMITED, Shenzhen, Guangdong (CN)

(21) Appl. No.: 14/006,044

(22) PCT Filed: Feb. 22, 2012
(86) PCT No.: PCT/CN12/71476

§ 371 Date: Sep. 18, 2013

(30) Foreign Application Priority Data
Mar. 21, 2011 (CN) 20110068030.2

(51) Int. Cl. H04W 4/02

(52) U.S. Cl. CPC H04W 4/02
USPC 455/456.3

(57) ABSTRACT

The present application discloses an information aggregation display method and device for an LBS, for solving the technical problem in the existing LBS that as the information of a specific geographic location is relatively scattered and the user is unable to obtain concentratedly and upload the geographic location information and the user generated content related to the certain specific geographic location. In the LBS system, the disclosure provides an aggregation display port to enable the user to intensively display the geographic location information and the user generated content related to the specific geographic location via the aggregation display interface; and provides an interaction port to enable the authorized user to publish articles and comments and to upload the user generated content such as pictures and videos on the aggregation display interface. The disclosure improves the efficiency of obtaining and interacting the information related to the specific geographic location by the user, extends the function of the LBS system, enhances the correlation between the LBS system and the correlated systems, and improves the product experience of the user.

### TECHNICAL FIELD

The disclosure relates to the field of Location Based Service (LBS) and internet technologies, and in particular to an information aggregation display method and device for LBS.

### BACKGROUND

The LBS system is a value added service which obtains the location information (geographic coordinates or geodetic coordinates) of a mobile terminal user via the radio communication networks (such as the Global System for Mobile Communications (GSM) network and the Code Division Multiple Access (CDMA) network) or the external positioning mode (such as the Global Positioning System (GPS)) of the telecom mobile operators, and which provides corresponding services for the user under the support of the Geographic Information System (GIS) platform.

The characteristics of the LBS mainly include the followings. 1. High requirements on coverage rate. On one hand, the coverage range is required to be large enough, and on the other hand, the coverage range is required to include indoor areas. As the users employ the function in the room for most of the time, each corner from the high-rise buildings to the underground facilities must be guaranteed to be covered. According to the scope of the coverage rate, the LBS can be divided into three types with three coverage rates: covering the entire local network, covering part of the local network, and providing roaming network service types. Except considering the coverage rate, the network structure and the environment factors which are dynamically changed may cause that a telecom operator cannot guarantee the services in the local network or the roaming network. 2. Requirements on positioning accuracy based on user demand.

The mobile phone positioning service should provide different accuracy services according to different user service demands, and can enable the users to select the accuracy. For example, the probability is 67% when the positioning accuracy launched by the United States Federal Communications Commission (FCC) is within 50 m and the probability is 95% when the positioning accuracy is within 150 m. The positioning accuracy not only relates to the adopted positioning technology, but also depends on the external environment which provides the service, wherein the external environment includes the radio propagation environment, the density and geographic location of base station, and the devices for positioning and the like.

The LBS, considered as one of the killer services after the Short Messaging Service (SMS), has a huge market size and an excellent profit prospect, but its actual progress is relatively slow. However, the mobile location and the LBS market are expected to be growing with the improvement of the industrial chain. The global LBS operation market has begun to accelerate in growing since 2008, it however must pay high attention to the equilibrium point between the service and the network performance while developing, so that the service development can be guaranteed as much as possible while guaranteeing the network performance.

The LBS based on the Cell Identity (Cell-ID) is one of the three main LBS technologies. The Cell-ID determines the user location by identifying which cell in the network transmits the calls of the user and by translating the information into latitude and longitude. The LBS based on the Cell-ID is preferably applied in the rural areas with low density. It is difficult for the LBS based on the Cell-ID to compete with the Enhanced Observed Time Difference (E-OTD) technology and the GPS technology due to lack of accuracy, and the LBS based on the Cell-ID is not suitable for certain commercial purposes, such as LBS advertisements which need to determine the accurate location of the user.

The Check in operation specifically refers to a function that the user marks his/her own location (where I am) in an internet product which contains the LBS. It also can be represented by the vocabularies such as register, sign-in, foot-printing and the like.

In the existing LBS, if the information of a certain geographic location (such as a certain commercial district and a certain scenic spot) is scattered, the user cannot obtain concentratedly the geographic location information and the user uploading information related to the geographic location, or also cannot upload photos and make comments related to the geographic location in the LBS, it is thus difficult for a user to obtain the information related to the geographic location information.

### SUMMARY

In view of the above, the main purpose of the disclosure is to provide an information aggregation display method and device for the LBS, for solving the technical problem in the existing LBS that the information of a specific geographic location is scattered such that the user cannot obtain concentratedly and upload both the geographic location information and the user generated content which are related to the specific geographic location.

In order to achieve the purpose, the technical solution of the disclosure is as follows.

An information aggregation display method for an LBS includes:
in an LBS system, an aggregation display port is provided for aggregating and displaying geographic location information related to a specific geographic location and user generated content related to the specific geographic location which is stored inside or outside the LBS system;
when an aggregation display request is received from a user, the aggregation display port is invoked via an aggregation display interface in the LBS system to display the geographic location information and the user generated content related to the specific geographic location for the user.

Further, the LBS system may provide an access port for the inside of the LBS system and for a correlated system, wherein the access port may be configured to enable a user of the LBS system and a user of another service system associated with the LBS system to access the aggregation display interface, so as to display the geographic location information and the user generated content related to the specific geographic location.

Further, the service system associated with the LBS system may include one or more of the following: a search engine system, a micro-blog system, an encyclopedic knowledge system, a portal system, a community system and a forum system.

Further, the specific geographic location may be characterized via one or more of the following information: a geographic address and/or name information, an address and/or name of a social enterprise or an institution, an address and/or name of a merchant or a firm; the geographic location information and the user generated content may include one or more of the following: words, pictures, photos, videos and audios.

Further, the method may include: an interaction interface is provided in the aggregation display interface, wherein the interaction interface may invoke an interaction port provided by the LBS system, and the interaction port may be configured to enable the user to upload, download and comment on the user generated content.

Further, the method may include: when the user accesses the aggregation display interface, verification and authentication is performed on a user Identity (user ID), wherein users with different IDs and permissions are corresponding to different levels of content browsing permissions and content uploading permissions.

Based on the embodiment of the disclosure, the disclosure also provides an information aggregation display device for an LBS, which is applied in an LBS systems and includes:
an aggregation display port, configured to receive an aggregation display request, to enable a user of the LBS system and a user of another service system associated with the LBS system to access an aggregation display interface, and to feed back geographic location information and user generated content related to a specific geographic location according to a request of the user; and
a storage module, configured to store the geographic location information and the user generated content related to the specific geographic location.

Further, the device may also include:
an interaction port, which is invoked by the aggregation display interface and is configured to enable the user to upload, download and comment on the user generated content in an interaction interface provided by the aggregation display interface.

Further, the device may also include:
a verification module, configured to verify a user ID and authenticate a user when the user accesses the aggregation display interface, wherein the aggregation display port and the interaction port perform content control and access control on users with different IDs and permissions according to a verification result from the verification module.

The disclosure provides an aggregation display port in an LBS system to enable the user to display concentratedly the geographic location information and the user generated content related to the specific geographic location via an aggregation display interface; and provides an interaction port to enable an valid authorized user to publish articles and comments and to upload the user generated content (such as pictures and videos) on the aggregation display interface. The disclosure improves the efficiency of obtaining and interacting the information related to the specific geographic location by the user, extends the function of the LBS system, enhances the correlation between the LBS system and the correlated systems, and improves the product experience of the user.

### BRIEF DESCRIPTION OF THE DRAWINGS

FIG. 1 shows a flow diagram of an information aggregation display method for the LBS according to the disclosure;

FIG. 2 shows a flow diagram of a method for a user to upload the user generated content according to the disclosure;

FIG. 3 shows a structure diagram of an information aggregation display device for the LBS according to the disclosure.

### DETAILED DESCRIPTION

In order to make the purposes, the technical solutions and the advantages of the disclosure clearer, the disclosure is further described below in details with reference to the embodiments and drawings.

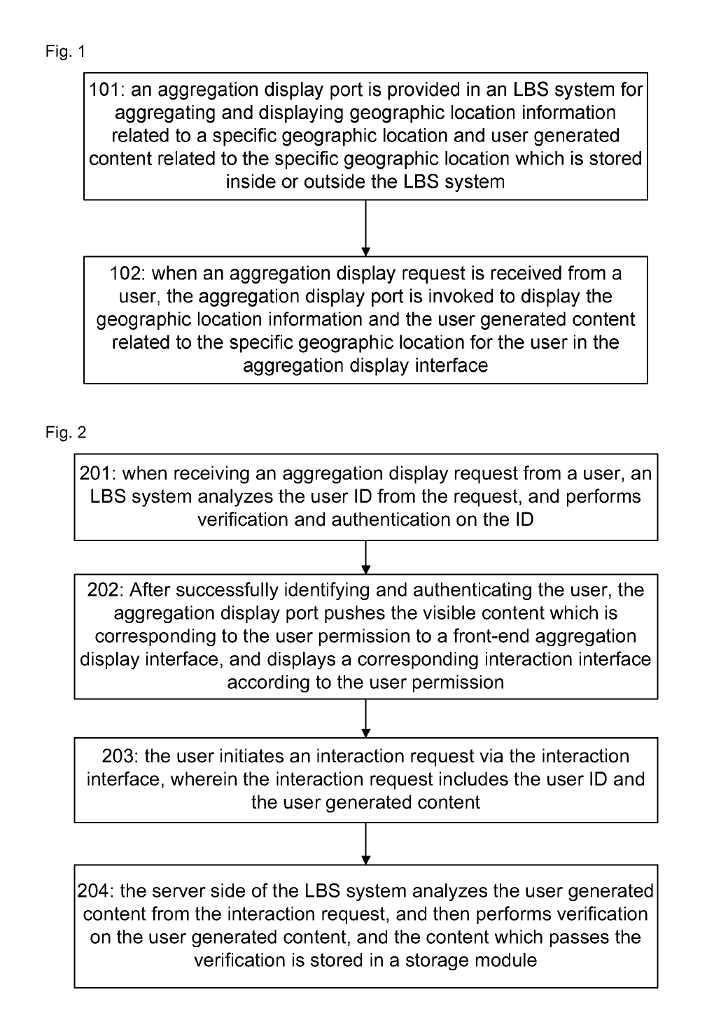

FIG. 1 shows a flow diagram of an information aggregation display method for LBS according to the disclosure. The method includes the following steps.

Step 101, an aggregation display port is provided in an LBS system for aggregating and displaying geographic location information related to a specific geographic location and user generated content related to the specific geographic location which is stored inside or outside the LBS system.
the LBS system provided in the embodiment of the disclosure refers to a service system which is based on the internet and is capable of providing the LBS. The disclosure does not limit the specific framework of the LBS system, which may be implemented as a WEB server mode or a server/client mode. In the LBS system, the browser terminal/client terminal (referred as terminal hereafter) is mainly configured to provide a display-and-exchange interface, without taking charge of the specific service logic. The terminal includes, but is not limited to a terminal device such as a Personal Computer (PC), a mobile phone, a tablet PC and the like.

The specific geographic location may be characterized or identified via one or more of the following: the geographic address and/or geographic name information, the address and/or address name of a social enterprise or an institution, the address and/or name of a merchant or a firm, such as the address or name of a merchant, an enterprise, a hospital, a store, an entertainment venue, a hotel and a scenic spot. The user generated content includes, but is not limited to the articles and comments published by the user, and the pictures, photos, videos, animations, audios and the like uploaded by the user.

The geographic location information related to the specific geographic location includes, but is not limited to the name, detailed address, brief introduction, picture introduction, video introduction and the like of the geographic location, and the display type is not limited to one or more of: words, pictures, photos, videos and audios.

The aggregation display port is invoked by an aggregation display interface, and is configured to obtain the geographic location information and the user generated content related to the specific geographic location from the LBS system. Certainly, the port can also be extended, so as to obtain the user generated content related to the specific geographic location which is stored in another system associated with the LBS system. The service system associated with the LBS system include one or more of the following: the search engine, the micro-blog, the encyclopedic knowledge system, the portal system, the community system and the forum system. For example, the user generated content related to the specific geographic location may be obtained from the encyclopedic knowledge system.

Step 102, when an aggregation display request is received from a user, the aggregation display port is invoked to display the geographic location information and the user generated content related to the specific geographic location for the user in the aggregation display interface.

When receiving the aggregation display request sent by the user, the server of the LBS system invokes the aggregation display port to obtain the geographic location information and the user generated content related to the specific geographic location, to generate the aggregation display interface, and to feed back the generated aggregation display interface to the terminal of the user. The terminal displays the aggregation display interface via the display port.

The user generates the aggregation display request via different modes. The different modes mentioned herein include but are not limited to the positioning function and searching function owned via the LBS, and the information generated by other users (such as friends) associated with the user, and the like. it can be easily understood by ordinary product designers that the aggregation display interface can be accessed via various modes. In order to enable other systems associated with the LBS system to directly access the aggregation display interface, the aggregation display port can be extended, for example, providing a corresponding WEB service port and the like.

Based on the above method, another embodiment of the disclosure provides an interaction port and an interaction interface, so that a user can upload, download and review the user generated content via the interaction port and the interaction interface. Preferably, the interaction interface is provided in the aggregation display interface, the interaction port is invoked by the interaction interface, and the interaction port can implement the function of uploading, downloading, reviewing and the like for the user.

The application scene of the disclosure is described by taking a network community system (referred as community hereafter) as the correlated system of the LBS system as an example. The LBS system and the community implement correlation of the user information via the user ID. After a friend of a certain user publishes an article related to a specific geographic location, or uploads photos and videos related to the specific geographic location in the LBS system, the community system will push the recent news of the friend of the user to the community home of the user, for example, providing a summary text link to describe what content the friend of the user publishes. When the user finds that his friend publishes the article related to the specific geographic location in the LBS system after logging in his own community home, the user can click on the text link, and this text link is immediately triggered to send an aggregation display request to the LBS system, so that the user can directly jump to the LBS system, and the aggregation display interface can be displayed to the user. Certainly, the aggregation display request needs to include the parameter information such as the geographic location ID and the user ID. After receiving the aggregation display request, the LBS system analyzes the parameters in the request, and then uses the obtained parameters as the parameters of the aggregation display port to obtain the display content.

Preferably, in another specific embodiment of the disclosure, when a user accesses the aggregation display interface, the method also includes the step of verifying and authenticating the user ID, the users with different IDs and permissions are corresponding to content browsing permissions and content uploading permissions with different levels.

FIG. 2 shows a flow diagram of a method for a user to upload the user generated content according to the disclosure. The method includes the following steps.

Step 201, when receiving an aggregation display request from a user, an LBS system analyzes the user ID from the request, and verifies whether the user ID is valid. If the user is not a valid user of the LBS system, the LBS system denies the access of this user. If the user is a valid user of the LBS system, the LBS system obtains the user permission from the system database, and determines whether the requested content meets the permission, if not, indicates the user of unauthorized access information; if yes, sends the content requested by the user, and makes the content displayed on the aggregation display interface. In the disclosure, the users with different IDs and permissions can be correspondingly set with different levels of content browsing permissions and content uploading permissions. The aggregation display port invokes the verification and authentication port to verify the ID and permission of a user before obtaining the content. It is determined, according to the user information, the content which is allowed to be browsed by the user and the content uploading operation which is allowed to be implemented by the user.

Step 202, after successfully verifying and authenticating the user, the aggregation display port pushes the visible content corresponding to the user permission to the front-end aggregation display interface, and displays the corresponding interaction interface according to the user permission.

The displayed content includes, but is not limited to words, pictures, videos, audios, flash, checking records and the like. The contents may be separately displayed, or may be displayed according to different classifications and combinations. And this is determined according to various functions of the elements which are freely combined by the products.

The displayed content is generated by different users, the users generate the content via the interaction interface on the aggregation display interface, for example, providing on the aggregation display interface interaction buttons, or embedded pages or controls for publishing articles and uploading photos and comments. The contents are displayed according to various classifications and ordering rules, which include but are not limited to the time, regions, relations with the browsing user, content dimensions (including but not limited to the words, picture videos, audios, flash, checking records and the like). The mode of display of the contents includes but is not limited to the mode of summary and index, or the mode of the full-text display and the like.

Step 203, the user initiates an interaction request via the interaction interface, for example, the user requests to publish articles, comment on the articles published by other users, reply to a comment, upload or download picture videos and the like.

The interaction request needs to include the user ID and the user generated content. The interaction interface invokes the interaction port, and the interaction port firstly verifies the user permission, and further verifies the interaction request of the user after the user permission is successfully verified.

The interaction port can allow the user to generate content after the user is successfully verified. The user generated content includes but is not limited to words, pictures, videos, audios, flash, checking records and the like.

Step 204, after receiving the interaction request, the server side of the LBS system analyzes the user generated content from the request, and then verifies the user generated content, wherein the verification includes but is not limited to the ID authentication, word limit, permission, content approval meeting the regulations of the local law, and the like. the content which passes the verification will be stored in a storage module. For an illegal request, an error flag will be returned to the terminal, and a browser on the terminal or a client will lead the user to enter the fault tolerance flow.

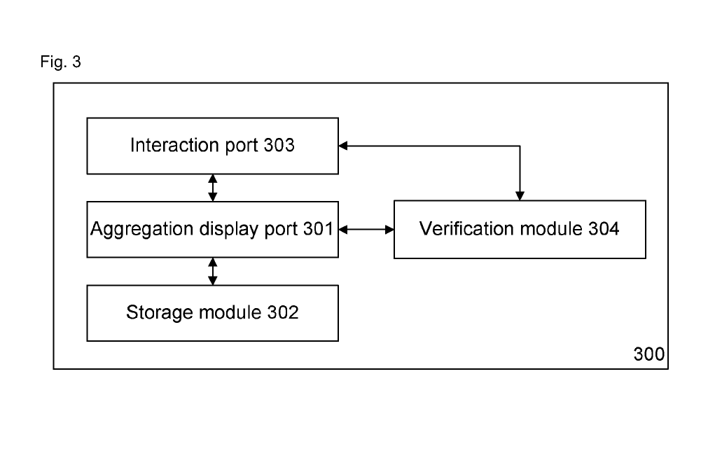

Based on the method flow of the disclosure, the disclosure also provides an information aggregation display device for the LBS. As shown in FIG. 3, the device which is applied in the LBS system, includes:
an aggregation display port 301, configured to receive an aggregation display request, to enable a user of the LBS system and a user of another service system associated with the LBS system to access an aggregation display interface, and to feed back geographic location information and user generated content related to a specific geographic location according to a request of the user; and
a storage module 302, configured to store the geographic location information and the user generated content related to the specific geographic location.

Preferably, the device may further include an interface port 303, which is invoked by the aggregation display interface and is configured to provide the function of uploading, downloading and commenting for the user in an interaction interface provided by the aggregation display interface.

Preferably, the device may further include a verification module 304, configured to verify a user ID and authenticate a user when the user accesses the aggregation display interface, wherein the aggregation display port and the interaction port perform content control and permission control on users with different IDs and permissions according to a verification result from the verification module. In addition, the verification module may also be responsible for implementing the operation such as verification of the user generated content in the interaction request.

The service system associated with the LBS system includes one or more of the following: a search engine, a blog system (including a micro-blog system), an encyclopedic knowledge system, a community system and a forum system.

The search engine refers to a system which adopts a specific computer program to collect information from the internet according to a specific strategy, provides retrieval service for the user after organizing and processing the information, and displays the related information retrieved by the user to the user system. The combination mode of the search engine system and the technical solution provided by the disclosure includes but is not limited to the following: when the result searched out by the search engine includes an identification of the specific geographic location, such as the merchant name, a hyperlink is provided for the identification, so that the user can jump to the LBS system from the hyperlink and open the aggregation display interface.

The blog system refers to a website system which is generally managed by individuals and irregularly posts new articles. The combination mode of the blog system and the technical solution provided by the disclosure includes but is not limited to the following: after a user publishes a blog text related to a specific geographic location, the blog text can be directly pushed to the LBS system of the present disclosure to be displayed on the aggregation display interface; and when the blog text includes an identification of the specific geographic location (such as the address of the merchant), a hyperlink is provided for the identification, so that the user can jump to the LBS system via the hyperlink and open the aggregation display interface.

The encyclopedic knowledge system is an encyclopedic knowledge sharing network system which can be self-managed and self-maintained by a network user, such as Baidu encyclopedia. This system is similar to the blog system, and the combination mode of the encyclopedic knowledge system and the technical solution of the disclosure can refer to the blog system, and is not repeated here.

The forum system is an electronic bulletin board system, also named as a Bulletin Board System (BBS). The combination mode of the forum system and the technical solution of the disclosure can also refer to the blog system, and is not repeated here.

The specific geographic location information may be characterized or identified according to one or more of the following: a geographic address and/or name information, an address and/or name of a social enterprise or an institution, an address and/or name of a merchant or a firm.

The geographic location information and the user generated content include one or more of the following: words, pictures, videos and audios.

As the device embodiment is implemented based on the information aggregation display method for the LBS which is provided in the above embodiment, each module in the device is set for realizing the step flows of the method, so the function of each module can be directly guided out from the method embodiment, and is not repeated here in order for concision.

The above are only preferred embodiments of the disclosure, but not intended to limit the protection scope of the disclosure.

### INDUSTRIAL APPLICABILITY

The disclosure improves the efficiency of obtaining and interacting the information related to the specific geographic location by the user, extends the function of the LBS system, enhances the correlation between the LBS system and the correlated systems, and improves the product experience of the user.

1. An information aggregation display method for a Location Based Service (LBS), comprising:
in an LBS system, providing an aggregation display port for aggregating and displaying geographic location information related to a specific geographic location and user generated content related to the specific geographic location which is stored inside or outside the LBS system;
when an aggregation display request is received from a user, invoking the aggregation display port via an aggregation display interface in the LBS system to display the geographic location information and the user generated content related to the specific geographic location for the user.

2. The method according to claim 1, wherein the LBS system provides an access port for the inside of the LBS system and for a correlated system, wherein the access port is configured to enable a user of the LBS system and a user of another service system associated with the LBS system to access the aggregation display interface, so as to display the geographic location information and the user generated content related to the specific geographic location.

3. The method according to claim 2, wherein the service system associated with the LBS system comprises one or more of the following: a search engine system, a micro-blog system, an encyclopedic knowledge system, a portal system, a community system and a forum system.

4. The method according to claim 1, wherein the specific geographic location is characterized via one or more of the following information: a geographic address and/or name information, an address and/or name of a social enterprise or an institution, an address and/or name of a merchant or a firm;
wherein the geographic location information and the user generated content comprise one or more of the following: words, pictures, photos, videos and audios.

5. The method according to claim 2, further comprising:
providing an interaction interface in the aggregation display interface, wherein the interaction interface invokes an interaction port provided by the LBS system, and the interaction port is configured to enable the user to upload, download and comment on the user generated content.

6. The method according to claim 5, further comprising:
when the user accesses the aggregation display interface, verifying and authenticating a user Identity (user ID), wherein users with different IDs and permissions are corresponding to different levels of content browsing permissions and content uploading permissions.

7. An information aggregation display device for a Location Based Service (LBS), applied in an LBS system, comprising:
an aggregation display port, configured to receive an aggregation display request, to enable a user of the LBS system and a user of another service system associated with the LBS system to access an aggregation display interface, and to feed back geographic location information and user generated content related to a specific geographic location according to a request of the user; and
a storage module, configured to store the geographic location information and the user generated content related to the specific geographic location.

8. The device according to claim 7, further comprising:
an interaction port, which is invoked by the aggregation display interface and is configured to enable the user to upload, download and comment on the user generated content in an interaction interface provided by the aggregation display interface.

9. The device according to claim 8, further comprising:
a verification module, configured to verify a user ID and authenticate a user when the user accesses the aggregation display interface, wherein the aggregation display port and the interaction port perform content control and access control on users with different IDs and permissions according to a verification result from the verification module.

10. The device according to claim 7, wherein the service system associated with the LBS system comprises one or more of the following systems: a search engine system, a micro-blog system, an encyclopedic knowledge system, a portal system, a community system and a forum system;
wherein the specific geographic location is characterized via one or more of the following information: a geographic address and/or name information, an address and/or name of a social enterprise or an institution, an address and/or name of a merchant or a firm;
wherein the geographic location information and the user generated content comprise one or more of the following: words, pictures, photos, videos and audios.
